(19) United States
(12) Patent Application Publication
(10) Pub. No.: US 2006/0163963 A1
(43) Pub. Date: Jul. 27, 2006

(54) Counter rotating generator

(76) Inventor: Paul Flores JR., Elyria, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/043,785

(22) Filed: Jan. 26, 2005

(51) Int. Cl. H02K 23/60

(52) U.S. Cl. 310/115

(57) ABSTRACT

A counter rotating generator has an outer housing including a cylindrical sidewall defining a pair of openings and a pair of circular mounting plates connected to the outer housing adjacent respective opposed ends thereof. A first shaft and an armature mounted thereon are rotatably mounted on one mounting plate. A second shaft and a field magnet mounted thereon via an inner housing is rotatably mounted on the other mounting plate in a direction opposite the armature. Slip rings are mounted on and encircle the inner housing. A pair of brush assemblies are mounted on the outer housing and extend respectively through the openings in sidewall thereof with brushes contacting the slip rings between and adjacent the inner housing and the outer housing sidewall. The large-diameter slip rings more quickly dissipate heat caused by frictional engagement of the brushes and slip rings, thus allowing the generator to operate at higher rates of revolution and higher temperatures.

### BACKGROUND OF THE INVENTION

1. Technical Field

The invention relates generally to counter rotating generators for producing electrical power. More particularly, the invention relates to such a generator which may be used at relatively high RPM's and relatively elevated temperatures. Specifically, the invention relates to such a generator having slip rings encircling a housing in which the field and armature are housed.

2. Background Information

Counter rotating generators are well-known in the art and their basic form involves a magnetic field or field part which is rotatable in a first direction and an armature or winding part which is rotatable in the opposite direction. This concept is particularly useful in wind generators and may also be used via the relative movement between the generator, propellers and other fluids or via any other power source for respectively rotating the field and the armature. With regard to wind generators, the counter rotating generator requires only approximately one-half of the wind speed to produce the same electricity as needed by a standard generator.

One of the drawbacks of such counter rotating generators is the tendency for them to overheat due to friction between brushes and slip rings or commutators. The commutators or slip rings are typically mounted on one or both of the shafts which respectively rotationally drive the field and the armature. Such commutators and slip rings have relatively small diameters and thus the frictional engagement with the brushes is incapable of easily dissipating the heat buildup therein. As a result, the relative rotational velocity of such generators must be limited.

The present invention overcomes this and other problems as will be discerned from the following description.

### BRIEF SUMMARY OF THE INVENTION

The present invention provides a counter rotating generator comprising a field part rotatable in a first direction about an axis and having a radially outermost terminus defining a first circular path of rotation about the axis; the first circular path having a first radius; a winding part rotatable about the axis in a second direction opposite the first direction; the winding part having a radially outermost terminus defining a second circular path of rotation about the axis; the second circular path having a second radius; a pair of slip rings mounted on and rotatable with one of the field part and the winding part; each slip ring defining a circular path of rotation about the axis having a third radius greater than at least one of the first and second radii.

The present invention further provides a counter rotating generator comprising a rigid mounting frame having first and second opposed ends and defining an axis extending from the first end to the second end; the mounting frame including a first mounting member adjacent the first end thereof, a second mounting member adjacent the second end thereof and a sidewall extending from the first mounting member to the second mounting member distal the axis; a brush assembly connected to the sidewall of the mounting frame and including a plurality of brushes extending toward the axis; a field part disposed between the first and second mounting members and mounted rotatably on the first mounting member about the axis in a first direction; a winding part disposed between the first and second mounting members and mounted rotatably on the second mounting member about the axis in a second direction opposite the first direction; and a plurality of slip rings which are rotatable about the axis with one of the field part and the winding part and in contact respectively with the plurality of brushes adjacent the sidewall of the mounting frame.

### BRIEF DESCRIPTION OF THE SEVERAL VIEWS OF THE DRAWINGS

FIG. 1 is a perspective view of the wind generator utilizing the counter rotating generator of the present invention.

FIG. 2 is a perspective view of the generator of the present invention with one side of brush assemblies removed.

FIG. 3 is an exploded perspective view of the generator.

FIG. 4 is a sectional view taken from the side of the generator.

FIG. 5 is an enlarged sectional view of the slip rings as shown in the inset portion of FIG. 4.

FIG. 6 is a sectional view taken on line 6-6 of FIG. 4.

FIG. 7 is a perspective view of the generator using with hand cranks.

Similar numbers refer to similar parts throughout the specification.

### DETAILED DESCRIPTION OF THE INVENTION

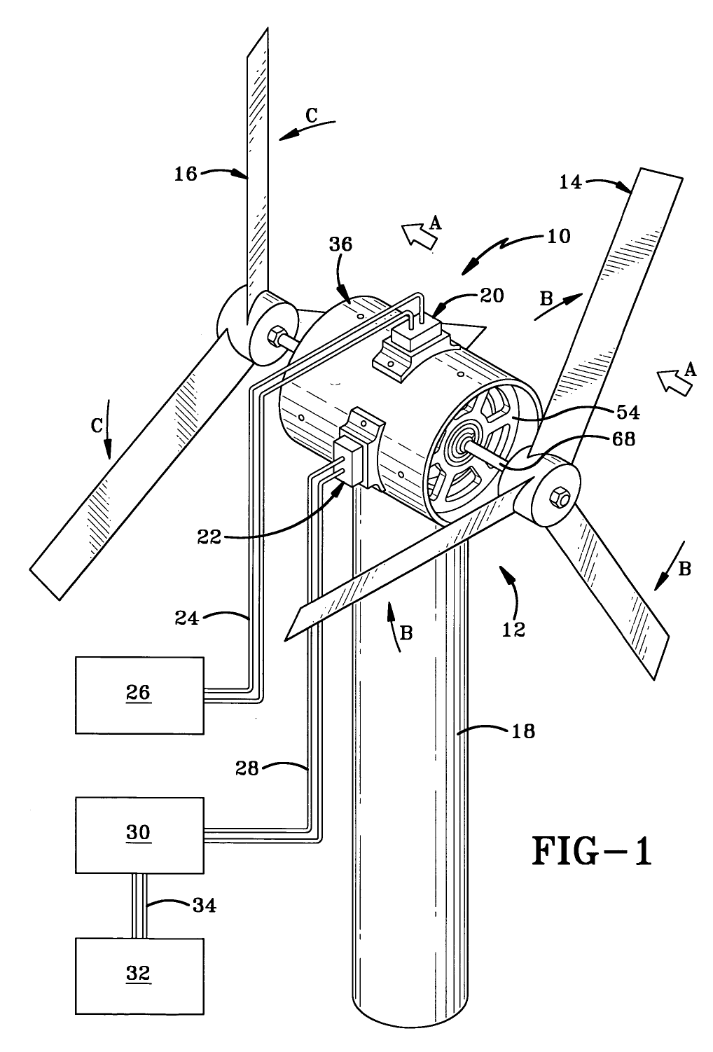

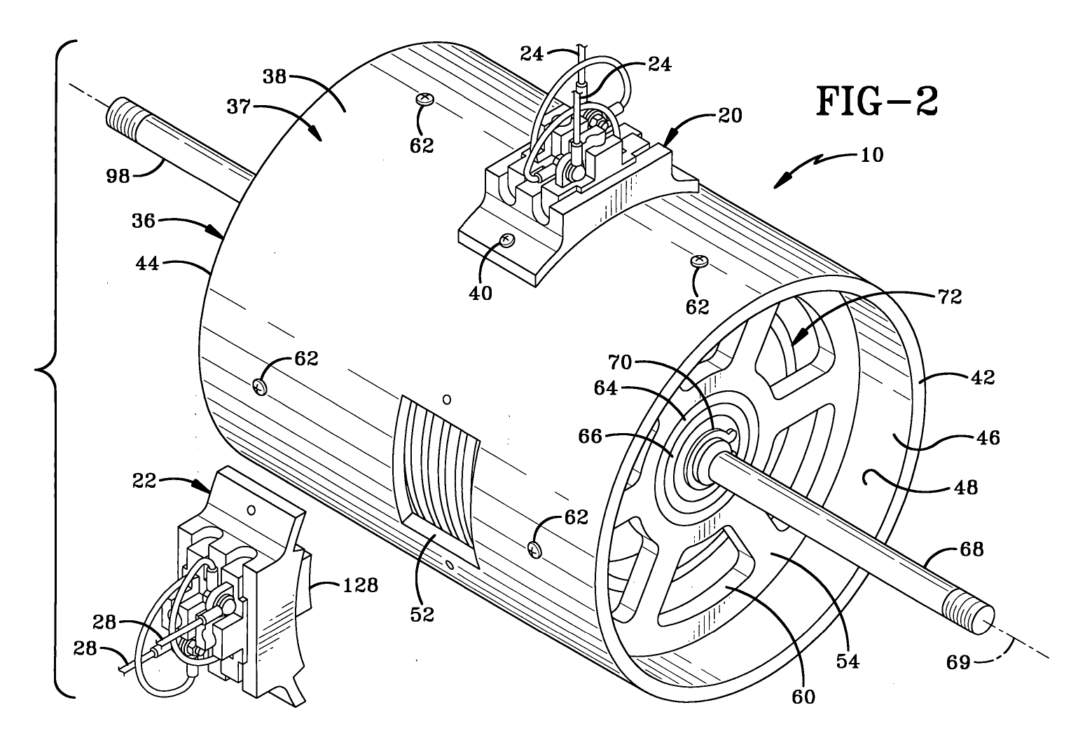

The counter rotating generator of the present invention is indicated generally at 10 in FIGS. 1-2. FIG. 1 shows generator 10 being used as part of a wind generator 12 wherein air moving in the direction indicated by arrows A rotates a first propeller 14 in the direction indicated by arrows B and a second propeller 16 in the direction indicated by arrows C which is opposite to the direction indicated by arrows B. Generator 10 is seated atop a stand 18 and has first and second brush assemblies 20 and 22 mounted thereon. A pair of wires 24 is in communication with first brush assembly 20 and an electrically operated device 26. Another pair of wires 28 is in electrical communication with brush assembly 22 and a regulator 30 which is in electrical communication with electrically operated device 32 via a pair of wires 34.

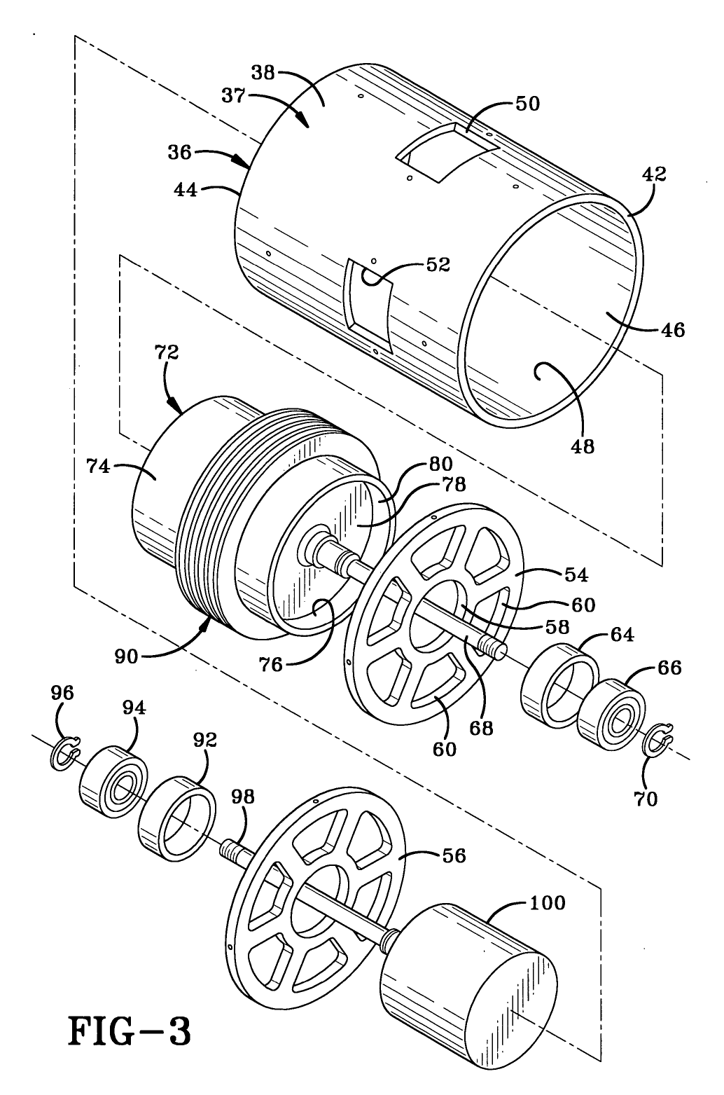

With reference to FIGS. 2 and 3, generator 10 includes a rigid mounting frame in the form of an external housing 36 which includes a cylindrical sidewall 37 having an outer surface 38 on which first and second brush assemblies 20 and 22 are removably mounted via fasteners 40 typically in the form of a screw. Sidewall 37 of housing 36 has a first end 42, second end 44 and a cylindrical inner surface 46 defining an interior chamber 48. Sidewall 37 defines a first opening 50 (FIG. 3) for the mounting of first brush assembly 20 and a second opening 52 for the mounting of second brush assembly 22. More particularly, each brush assembly 20 and 22 has a portion respectively disposed within openings 50 and 52, said portion including a portion of brushes 124 and 128 respectively. The external mounting of brush assemblies 20 and 22 makes them easily accessible for removal to facilitate repair and/or replacement thereof.

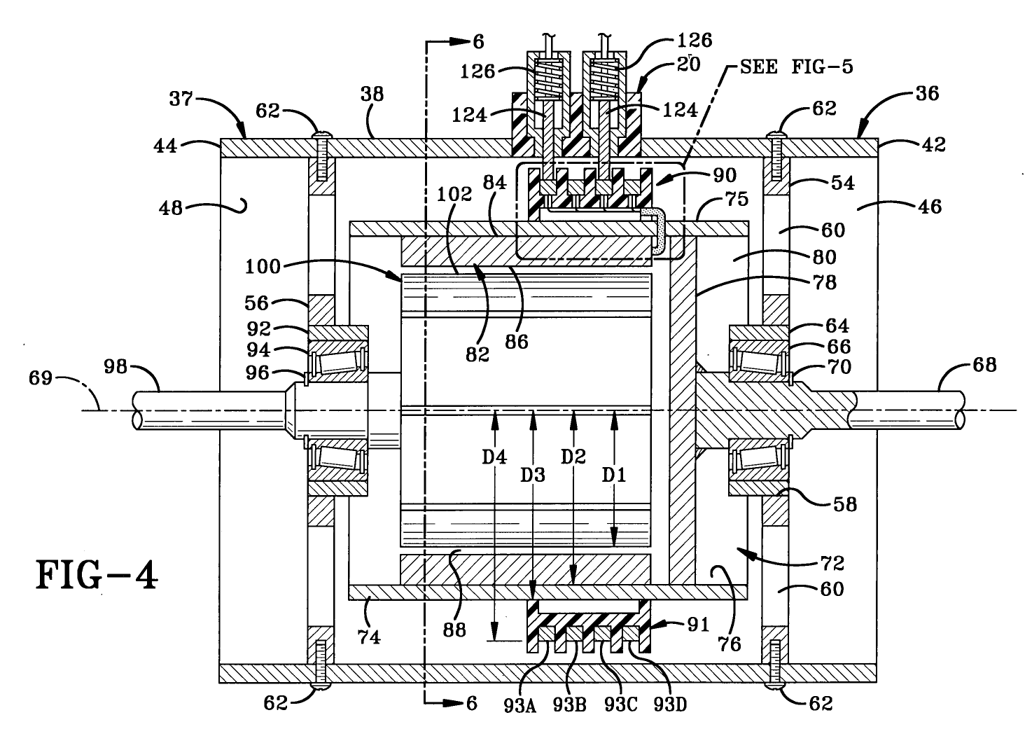

With continued reference to FIGS. 2 and 3, generator 10 further includes a pair of mounting members in the form of a first mounting plate 54 and second mounting plate 56 (FIG. 3). First mounting plate 54 defines a central cylindrical opening 58 and plurality of ventilation openings 60 spaced radially outwardly from opening 58. First mounting plate 54 is spaced inwardly from first end 42 of housing 36 within interior chamber 48 and mounted to sidewall 37 with fasteners 62 via respective holes (not shown) in sidewall 37 and mounting plate 54. A cylindrical bushing 64 is disposed within central opening 58 of first mounting plate 54 with bearing 66 mounted within bushing 64. A first shaft 68 extends through and is rotatably mounted about an axis 69 (FIG. 4) on bearing 66 and secured in place by retaining clip 70.

With reference to FIGS. 3 and 4, an inner housing 72 is mounted on first shaft 68 and includes a cylindrical sidewall 74. Sidewall 74 has an outer surface 75 including an outermost terminus and defines an interior chamber 76. Housing 72 further includes an end wall 78 mounted within interior chamber 76. More particularly, end wall 78 is rigidly mounted on first shaft 68. Sidewall 74 has a cylindrical inner surface 80 bounding interior chamber 76. An annular field part or field magnet 82 (FIG. 4) is rigidly mounted to sidewall 74 along inner surface 80 within chamber 76. Magnet 82 has a substantially cylindrical outer periphery 84 defining an outermost terminus which is a radially most distant point of field magnet 82 from axis 69. Field magnet 82 has a substantially cylindrical inner surface 86 defining an interior chamber 88.

In accordance with a feature of the invention and with continued reference to FIGS. 3 and 4, a slip ring assembly 90 is mounted to sidewall 74 of inner housing 72 along and adjacent outer surface 75 thereof. Slip ring assembly 90 includes an insulator 91 and four slip rings 93A-D mounted thereon. Slip ring assembly 90 is described in greater detail further below. Second mounting plate 56 is essentially the same as first mounting plate 54 and is mounted within interior chamber 48 of external housing 36 in the same manner as first mounting plate 54 adjacent second end 44 of housing 36. Generator 10 further includes a bushing 92, a bearing 94, a clip ring 96, and second shaft 98, all mounted in the same fashion with relation to second mounting plate 56 as described with the corresponding parts with regard to first mounting plate 54. Second shaft 98 is rotatable about axis 69. Winding part or armature 100 is rigidly mounted on second shaft 98 and is disposed in interior chamber 88 of field magnet 82. Armature 100 has an outer periphery 102 including an outermost terminus which is the radially outermost point of armature 100 from axis 69.

Outer periphery 102 of armature 100 including the outermost terminus thereof is spaced a radial distance D1 from axis 69 or, in other words, said outermost terminus defines a circular path of rotation having a radius D1 during rotation of armature 100. Outer periphery 84 of field magnet 82 including the outermost terminus thereof is spaced a radial distance D2 from axis 69, distance D2 being the radius of a circular path defined by the outermost terminus of field magnet 82 during rotation thereof. Outer surface 75 of sidewall 74 of inner housing 72 is spaced a radial distance D3 from axis 69. Thus, similarly, the outermost terminus of sidewall 74 defines a circular path of rotation with a radius D3 driving rotation of sidewall 74. Each slip ring 93 and in particular an outermost portion thereof is spaced a radial distance D4 from axis 69 and defines a circular path of rotation with a radius D4 during rotation of slip rings 93. Distance D4 is greater than distance D3, which is greater than distance D2, which is greater than distance D1.

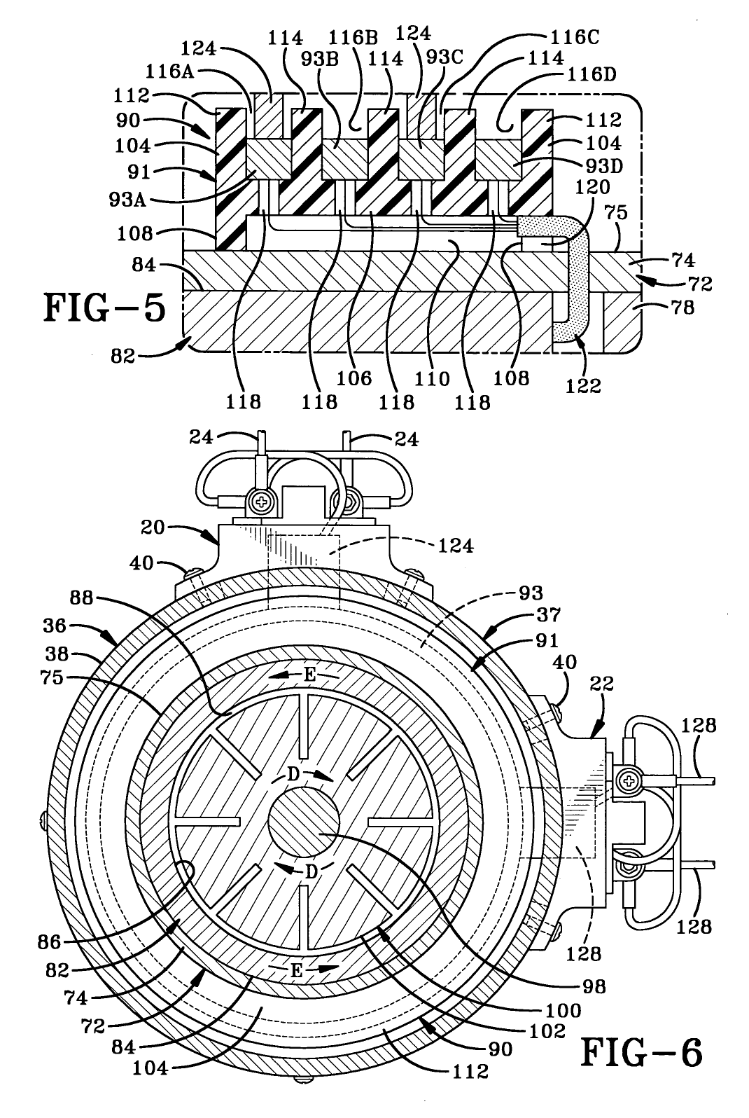

Slip ring assembly 90 is now described in further detail with reference to FIG. 5. Insulator 91 includes a pair of spaced cylindrical sidewalls 104 joined by a cylindrical laterally extending joining wall 106. Each sidewall 104 has a lower portion 108 which contacts outer surface 75 of inner housing 72 whereby joining wall 106 is spaced from upper surface 75 to define a wire receiving space 110. Each sidewall 104 also includes an upper projection 112 which extends upwardly of joining wall 106. Insulator 91 includes three spaced cylindrical projections 114 extending from joining wall 106 whereby projection 114 and upper projections 112 define respectively there between cylindrical channels 116 A-D in which are disposed respectively slip rings 93A-D. Joining wall 106 defines four through holes 118, each communicating with wire receiving space 110 and a respective one of channels 93A-D. A hole 120 is formed in lower portion 108 of one of insulator sidewalls 104 through which an electrical pathway 122 is received for communication of electric current generated by generator 10 as known in the art to slip rings 93. In particular, electrical pathway 122 includes four wires which respectively communicate electrically with slip rings 93A-D.

With reference to FIGS. 4-5, first brush assembly 20 includes a pair of brushes 124, each of which is spring biased by respective spring 126 (FIG. 4) into electrical contact respectively with slip ring 93A and slip ring 93C. Second brush assembly 22 has a pair of brushes 128 (FIG. 6) and has the same configuration as first brush assembly 20, except brushes 128 are spring biased into electrical contact with slip rings 93B and 93D. Each slip ring 93 contacts a respective brush 128 adjacent outer surface 75 of sidewall 74 of inner housing 72 and also adjacent sidewall 37 of external housing 36, in particular adjacent a respective one of openings 50 and 52 (FIG. 3) in sidewall 37.

The positioning slip rings 93 around inner housing 72, field magnet 82 and armature 100 allows generator 10 to have a shorter length as measured in the direction of axis 69. In contrast to many other counter rotating generators, no brushes, slip rings or commutators are disposed between first mounting plate 54 and any of field magnet 82, armature 100 or inner housing 72. Likewise, no brushes, slip rings or commutators are disposed between second mounting plate 56 and any of field magnet 82, armature 100 or inner housing 72. In addition, unlike many other counter rotating generators, no brushes, slip rings or commutators are disposed outwardly along axis 69 of either of first mounting plate 54 or second mounting plate 56. More broadly, no brushes, slip rings or commutators are disposed outwardly along axis 69 of field magnet 82, armature 100 or inner housing 72.

In operation, generator 10 functions similar to other counter rotating generators except for the inclusion of slip ring assembly 90. Thus, as seen in FIG. 6, second shaft 98 and armature 100 rotate in the direction indicated by arrows D, which corresponds with the rotation of second propeller 16 (FIG. 1). Simultaneously, field magnet 82, inner housing 72 and slip ring assembly 90 rotate in the direction indicated by arrows E, which corresponds with the rotation of first shaft 68 and propeller 14 (FIG. 1). This rotation is caused by the relative movement between wind or other fluid and propellers 14 and 16. As is commonly known, this produces an electrical current which is transmitted through the wires of electrical pathway 122 to respective slip rings 93A-D. Via brushes 124, the electrical current is transmitted from slip rings 93A and 93C to wires 24 (FIG. 1) in order to operate device 26. In addition, brushes 128 of second brush assembly 22 transmit electrical current from slip rings 93B and 93D through wires 28 (FIG. 1) to regulator 30 for regulation thereof as is known in the art in order to provide power to operate device 32 via wires 34.

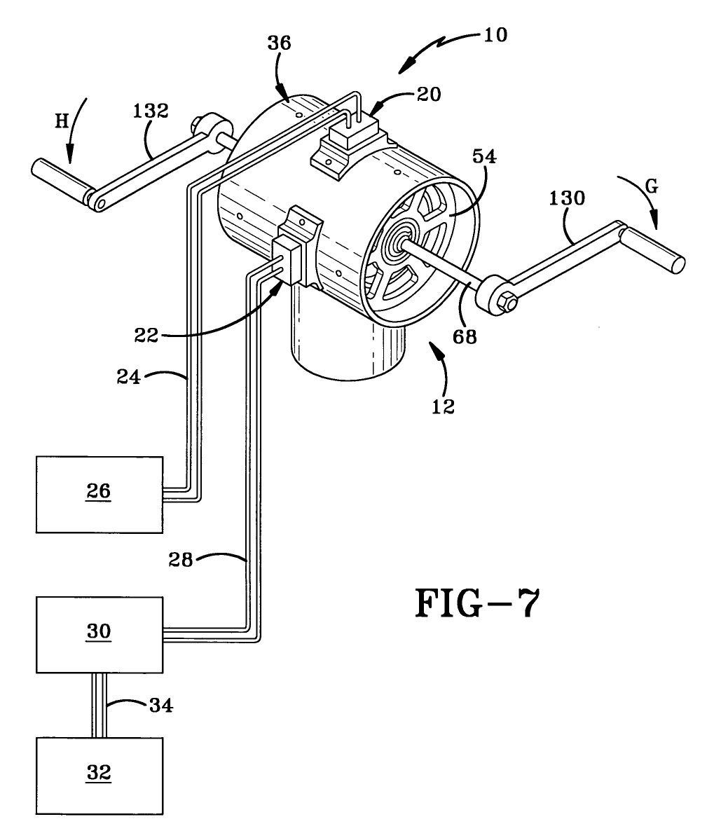

While generator 10 has been described as being powered by wind or other fluid source, it may also be powered by any other suitable source. FIG. 7 shows one such option wherein generator 10 is used with hand cranks instead of propellers. More particularly, a first hand crank 130 is connected to first shaft 68 and rotatable in the direction indicated by arrow G and a second handle 132 is connected to second shaft 98 and is rotatable as shown by arrow H in the opposite direction. Hand cranks 130 and 132 may be useful, for example, to operate counter rotating generator 10 in remote locations where electricity is unavailable.

Thus, the present application provides a counter rotating generator 10 which includes slip rings with far greater diameter with respect to the overall structure of the generator than is known in the prior art. As previously noted, the slip rings allow improved dissipation of heat produced by the frictional engagement of the brushes and the rotating slip rings so that generator 10 may be run at higher speeds and/or higher temperatures than other counter rotating generators. In addition, the ease of access to the brushes for removal and replacement thereof is an advantage over such generators having brushes internally disposed or otherwise configured to provide awkward access thereto. Further, the arrangement of slip rings and brushes of generator 10 allows for a shorter length generator, which may be useful in a variety of circumstances.

It will be appreciated by those skilled in the art that a variety of changes may be made which are within the scope of the present invention. For example, while it is preferred that the rigid mounting frame be in the form of an external housing, such as cylindrical housing 36, for protection from external elements and so forth, this is not necessary to the placement of the slip rings and brush assemblies. For example, instead of the cylindrical sidewalls, such as sidewall 37, and substantially circular mounting plates, such as plates 54 and 56, the mounting frame may be formed of mounting members in the form of bars or other suitable structure with a sidewall in the form of a bar extending between the two mounting bars wherein the brush assemblies are mounted on the sidewall in the form of mounting bar. Any suitable rigid mounting frame which allows the respective placement of the brush assemblies and the slip rings is within the scope of the invention.

In addition, the inner housing to which the field magnet or the armature is mounted does not need to be cylindrical, but may take on a variety of shapes. Clearly, it is most advantageous for this inner housing to have a cylindrical sidewall, such as sidewall 74, to facilitate the mounting of slip ring assembly 90 or a similar slip ring assembly. In addition, where the armature is suitably configured, the sidewall of the inner housing may be eliminated altogether wherein the field magnet is rigidly mounted on a rotatable shaft via an end wall, such as end wall 78 or another rigid structure. In such case, slip ring assembly 90 may be mounted directly on the armature or field magnet.

Further, as is known in the art, the field magnets and the armature may be in a variety of configurations with respect to one another. For instance, the armature may define an interior chamber within which the field magnet is disposed or the two members may be disposed adjacent one another, for instance, as indicated in U.S. Pat. No. 279,476 to Ball. Other variations within the scope of the invention will be evident to one skilled in the art.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A counter-rotating generator comprising:
a field part rotatable in a first direction about an axis and having a radially outermost terminus defining a first circular path of rotation about the axis; the first circular path having a first radius;
a winding part rotatable about the axis in a second direction opposite the first direction; the winding part having a radially outermost terminus defining a second circular path of rotation about the axis; the second circular path having a second radius;
a pair of slip rings mounted on and rotatable with one of the field part and the winding part; each slip ring defining a circular path of rotation about the axis having a third radius greater than at least one of the first and second radii.

2. The generator of claim 1 wherein the third radius is greater than the radius of the one of the field part and winding part on which the slip rings are mounted.

3. The generator of claim 1 wherein the third radius is greater than each of the first and second radii.

4. The generator of claim 1 wherein one of the field part and the winding part is mounted on and housed within a first housing having an outer surface; and wherein the slip rings are mounted on the first housing adjacent the outer surface thereof.

5. The generator of claim 4 wherein an insulator is mounted on the first housing; and wherein the slip rings are mounted on the insulator.

6. The generator of claim 5 wherein the insulator defines a wire-receiving space adjacent the outer surface of the first housing for receiving wires for carrying electrical current generated by the generator to the slip rings.

7. The generator of claim 4 wherein the other of the field part and the winding part is housed within the one of the field part and the winding part.

8. The generator of claim 4 wherein the field part is rigidly mounted on a first shaft and the winding part is rigidly mounted on a second shaft; and wherein the first and second shafts are rotatably mounted on a second housing in which are disposed the first housing, the field part and the winding part.

9. The generator of claim 1 wherein the field part is rigidly mounted on a rotatable first shaft; wherein the winding part is rigidly mounted on a rotatable second shaft; and wherein first and second propellers are mounted respectively on the first and second shafts.

10. The generator of claim 1 wherein each of the field part and the winding part are disposed within a first housing; wherein one of the field part and the winding part is rigidly mounted to the first housing; and wherein each slip ring extends around the first housing and is mounted on the one of the field part and the winding part via the first housing.

11. The generator of claim 10 wherein the field part and the winding part are each rotatably mounted on a second housing; wherein the first housing is housed within the second housing; and wherein a pair of brushes is mounted on the second housing in contact with the respective pair of slip rings.

12. The generator of claim 11 wherein the other of the field part and the winding part is housed within the one of the field part and the winding part which is mounted to the first housing.

13. The generator of claim 1 further including a housing having a sidewall; wherein the field part and the winding part are each rotatably mounted on the housing; and wherein a pair of brushes is mounted on the housing in contact with the respective pair of slip rings adjacent the sidewall.

14. The generator of claim 1 further including a housing having a sidewall defining an opening; wherein a brush assembly is mounted on the housing sidewall and disposed partially within the opening thereof; the brush assembly including a pair of brushes in contact respectively with the pair of slip rings.

15. The generator of claim 14 wherein the brushes are partially disposed within the opening in the housing sidewall.

16. The generator of claim 14 wherein the slip rings and brushes contact one another adjacent the opening in the housing sidewall.

17. The generator of claim 14 wherein the brush assembly is removably mounted on the housing sidewall and is accessible from a position external to the housing to facilitate removal from and mounting on the sidewall.

18. A counter-rotating generator comprising:
a rigid mounting frame having first and second opposed ends and defining an axis extending from the first end to the second end; the mounting frame including a first mounting member adjacent the first end thereof, a second mounting member adjacent the second end thereof and a sidewall extending from the first mounting member to the second mounting member distal the axis;
a brush assembly connected to the sidewall of the mounting frame and including a plurality of brushes extending toward the axis;
a field part disposed between the first and second mounting members and mounted rotatably on the first mounting member about the axis in a first direction;
a winding part disposed between the first and second mounting members and mounted rotatably on the second mounting member about the axis in a second direction opposite the first direction; and
a plurality of slip rings which are rotatable about the axis with one of the field part and the winding part and in contact respectively with the plurality of brushes adjacent the sidewall of the mounting frame.

19. The generator of claim 18 wherein one of the field part and the winding part is mounted on and housed within a first housing having an outer surface; wherein the slip rings are mounted on the first housing; wherein the slip rings contact the respective brushes adjacent the outer surface of the first housing; and wherein neither the slip rings nor the brushes are disposed between (1) the first mounting member and (2) the field and winding parts or between (3) the second mounting member and (4) the field and winding parts.

20. The generator of claim 18 wherein no brushes, slip rings or commutators are disposed outwardly of the field and winding parts in a direction along the axis.
